(19) United States
(12) Patent Application Publication
(10) Pub. No.: US 2009/0239987 A1
(43) Pub. Date: Sep. 24, 2009

(54) Halogen Flame Retardant Thermoplastic Polyurethane

(75) Inventor: Sridhar K. Siddhamalli, Strongsville, OH (US)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: LUBRIZOL ADVANCED MATERIALS, INC., Cleveland, OH (US)

(21) Appl. No.: 12/051,329

(22) Filed: Mar. 19, 2008

(51) Int. Cl. C08K 3/16

(52) U.S. Cl. 524/412; 524/411

(57) ABSTRACT

Thermoplastic polyurethane (TPU) formulations are disclosed which comprise a halogenated flame retardant together with an antimony oxide and talc. The formulations exhibit a high LOI (at least 30) and are V-0 rated on the UL-94 test. The halogenated flame retardant can be a chlorinated or brominated compound. The antimony oxide compound is selected from the group consisting of antimony trioxide and antimony pentaoxide. When brominated flame retardants are used, talc is not required, but is preferred to meet the high LOI and V-0 rating. The TPU formulations are useful for wire and cable jacketing applications and for jacketing for fiber optic cables.

### FIELD OF THE INVENTION

The present invention relates to flame retardant thermoplastic polyurethane (TPU) compositions, and more particularly to flame retardant thermoplastic polyurethane compositions comprising a halogen flame retardants together with talc. The TPU compositions are useful for applications where high flame performance is desirable, such as wire and cable and fiber optic cable applications, blown film, molding applications, and the like. This invention also relates to processes to produce the TPU compositions and processes to produce wire and cable jacketing.

### BACKGROUND OF THE INVENTION

Halogen additives, such as those based on fluorine, chlorine, and bromine, have been used to give flame retardant properties to TPU compositions. Compounds based on chlorine and bromine are particularly good selections for flame retardant additives to thermoplastics, such as TPU polymers, because of their relative cost, availability, and their effectiveness. The amounts of halogen based flame retardants used will vary depending on the flame retardant properties required for a given use.

TPU (thermoplastic polyurethane) polymers are typically made by reacting (1) a hydroxy terminated polyether or hydroxy terminated polyester, (2) a chain extender, and (3) an isocyanate compound. Various types for each of the three reactants are disclosed in the literature. The TPU polymers made from these three reactants find use in various fields where products are made by melt processing the TPU and forming it into various shapes. For many of these products, it is necessary to add flame retardants to the TPU. This is particularly important for wire and cable jacketing where the polymer used must meet stringent flame retardancy.

TPUs are segmented polymers having soft segments and hard segments. This feature accounts for their excellent elastic properties. The soft segments are derived from the hydroxyl terminated polyether or polyester and the hard segments are derived from the isocyanate and the chain extender. The chain extender is typically one of a variety of glycols, such as 1,4-butane glycol.

For TPU applications which must be flame retarded, an important property of the TPU compound is the limiting oxygen index (LOI). The LOI is the minimum percentage of oxygen which allows a sample to sustain combustion under specified conditions in a candle-like fashion. The higher the LOI value, the more the TPU compound is resistant to flame.

Previous commercial TPU compounds containing halogenated flame retardant additives have shown LOI values of from 25 up to about 30. An LOI of up to about 30 is adequate for several applications, but for tray cable applications, an LOI of about 35 to 36 is needed. A 5 or 6 unit increase in the LOI is a very appreciable amount and cannot be achieved by simply adding additional halogenated flame retardants. The TPU compound must also have good physical properties and processability to enable it to be useful.

It would be desirable to increase the LOI of TPU compounds using a halogenated flame retardant system, while retaining good physical properties and processability.

### SUMMARY OF THE INVENTION

It is an object of the present invention to make a thermoplastic polyurethane composition which has a Limited Oxygen Index (LOI) % of at least 30, preferably at least 31, 32, 33, 34 or 35, and more preferably at least 37, and particularly desirable would be a LOI of 40.

This objective is accomplished by using a halogenated flame retardant additive in the TPU composition together with an antimony oxide selected from the group consisting of antimony trioxide and antimony pentaoxide and talc. The halogenated flame retardant can be a chlorinated compound or a brominated compound. The talc is used at a level from 1 to 20 weight percent of the TPU composition, preferably from 3 to 15 weight percent, and more preferably from 5 to 10 weight percent.

It is another object of the present invention to make a halogenated flame retarded TPU composition which has a LOI % of greater than 30 and exhibits a V-O rating on the UL-94 test according to ASTM D-2863.

It is a further object of the present invention to make a halogenated flame retarded TPU composition which has a LOI % of at least 40 and exhibits a V-0 rating on the UL-94 test according to ASTM D-2863. This objective is accomplished by using a brominated flame retardant in combination with antimony trioxide and talc.

The TPU compositions must also be capable of melt processing to make products, such as by extrusion to make cable jacketing, as well as other desired products.

### DETAILED DESCRIPTION OF THE INVENTION

The thermoplastic polyurethanes (TPU for short) compositions of the present invention comprise at least one TPU polymer along with flame retardant additives to achieve good flame retardency.

The TPU polymer type used in this invention can be any conventional TPU polymer that is known to the art and in the literature as long as the TPU polymer has adequate molecular weight. The TPU polymer is generally prepared by reacting a polyisocyanate with an intermediate such as a hydroxyl terminated polyester, a hydroxyl terminated polyether, a hydroxyl terminated polycarbonate or mixtures thereof, with one or more chain extenders, all of which are well known to those skilled in the art.

The hydroxyl terminated polyester intermediate is generally a linear polyester having a number average molecular weight (Mn) of from about 500 to about 10,000, desirably from about 700 to about 5,000, and preferably from about 700 to about 4,000, an acid number generally less than 1.3 and preferably less than 0.8. The molecular weight is determined by assay of the terminal functional groups and is related to the number average molecular weight. The polyester intermediates are produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from, epsilon-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is the preferred acid. The glycols which are reacted to form a desirable polyester intermediate can be aliphatic, aromatic, or combinations thereof, and have a total of from 2 to 12 carbon atoms, and include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and the like, 1,4-butanediol is the preferred glycol.

Hydroxyl terminated polyether intermediates are polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethyl glycol) comprising water reacted with tetrahydrofuran (PTMG). Polytetramethylene ether glycol (PTMEG) is the preferred polyether intermediate. Polyether polyols further include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of THF and ethylene oxide or THF and propylene oxide. These are available from BASF as Poly THF B, a block copolymer, and poly THF R, a random copolymer. The various polyether intermediates generally have a number average molecular weight (Mn), as determined by assay of the terminal functional groups which is an average molecular weight, of from about 250 to about 10,000, desirably from about 500 to about 5,000, and preferably from about 700 to about 3,000.

The polycarbonate-based polyurethane resin of this invention is prepared by reacting a diisocyanate with a blend of a hydroxyl terminated polycarbonate and a chain extender. The hydroxyl terminated polycarbonate can be prepared by reacting a glycol with a carbonate.

U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and preferably 4 to 12 carbon atoms, and from polyoxyalkylene glycols containing 2 to 20 alkoxy groups per molecular with each alkoxy group containing 2 to 4 carbon atoms. Diols suitable for use in the present invention include aliphatic diols containing 4 to 12 carbon atoms such as butanediol-1,4, pentanediol-1,4, neopentyl glycol, hexanediol-1,6,2,2,4-trimethylhexanediol-1,6, decanediol-1,10, hydrogenated dilinoleylglycol, hydrogenated dioleylglycol; and cycloaliphatic diols such as cyclohexanediol-1,3, dimethylolcyclohexane-1,4, cyclohexanediol-1,4, dimethylolcyclohexane-1,3,1,4-endomethylene-2-hydroxy-5-hydroxymethyl cyclohexane, and polyalkylene glycols. The diols used in the reaction may be a single diol or a mixture of diols depending on the properties desired in the finished product.

Polycarbonate intermediates which are hydroxyl terminated are generally those known to the art and in the literature. Suitable carbonates are selected from alkylene carbonates composed of a 5 to 7 membered ring having the following general formula:

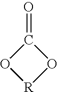

where R is a saturated divalent radical containing 2 to 6 linear carbon atoms. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate.

Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Preferred examples of diarylcarbonates, which can contain 6 to 20 carbon atoms in each aryl group, are diphenylcarbonate, ditolylcarbonate, and dinaphthylcarbonate.

The reaction is carried out by reacting a glycol with a carbonate, preferably an alkylene carbonate in the molar range of 10:1 to 1:10, but preferably 3:1 to 1:3 at a temperature of 100° C. to 300° C. and at a pressure in the range of 0.1 to 300 mm of mercury in the presence or absence of an ester interchange catalyst, while removing low boiling glycols by distillation.

More specifically, the hydroxyl terminated polycarbonates are prepared in two stages. In the first stage, a glycol is reacted with an alkylene carbonate to form a low molecular weight hydroxyl terminated polycarbonate. The lower boiling point glycol is removed by distillation at 100° C. to 300° C., preferably at 150° C. to 250° C., under a reduced pressure of 10 to 30 mm Hg, preferably 50 to 200 mm Hg. A fractionating column is used to separate the by-product glycol from the reaction mixture. The by-product glycol is taken off the top of the column and the unreacted alkylene carbonate and glycol reactant are returned to the reaction vessel as reflux. A current of inert gas or an inert solvent can be used to facilitate removal of by-product glycol as it is formed. When amount of by-product glycol obtained indicates that degree of polymerization of the hydroxyl terminated polycarbonate is in the range of 2 to 10, the pressure is gradually reduced to 0.1 to 10 mm Hg and the unreacted glycol and alkylene carbonate are removed. This marks the beginning of the second stage of reaction during which the low molecular weight hydroxyl terminated polycarbonate is condensed by distilling off glycol as it is formed at 100° C. to 300° C., preferably 150° C. to 250° C. and at a pressure of 0.1 to 10 mm Hg until the desired molecular weight of the hydroxyl terminated polycarbonate is attained. Molecular weight (Mn) of the hydroxyl terminated polycarbonates can vary from about 500 to about 10,000 but in a preferred embodiment, it will be in the range of 500 to 2500.

Suitable extender glycols (i.e., chain extenders) are lower aliphatic or short chain glycols having from about 2 to about 10 carbon atoms and include for instance ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol hydroquinone di(hydroxyethyl)ether, neopentyglycol, and the like, with 1,4-butanediol being preferred.

The desired TPU polymer used in the TPU composition of this invention is generally made from the above-noted intermediates such as a hydroxyl terminated polyesters, polyether, or polycarbonate, preferably polyether, which is further reacted with a polyisocyanate, preferably a diisocyanate, along with extender glycol desirably in a so-called one-shot process or simultaneous coreaction of polyester, polycarbonate or polyether intermediate, diisocyanate, and extender glycol to produce a high molecular weight linear TPU polymer. The preparation of the macroglycol is generally well known to the art and to the literature and any suitable method may be used. The weight average molecular weight (Mw) of the TPU polymer is generally about 80,000 to 500,000 Daltons, and preferably from about 90,000 to about 250,000, as measured according to gel permeation chromatography (GPC) against polystyrene standards. The equivalent weight amount of diisocyanate to the total equivalent weight amount of hydroxyl containing components, that is the hydroxyl terminated polyester, polyether, or polycarbonate, and chain extender glycol, is from about 0.95 to about 1.10, desirably from about 0.96 to about 1.02, and preferably from about 0.97 to about 1.005. Suitable diisocyanates include aromatic diisocyanates such as: 4,4′-methylenebis-(phenyl isocyanate) (MDI); m-xylylene diisocyanate (XDI), phenylene-1,4-diisocyanate, naphthalene-1,5-diisocyanate, diphenylmethane-3,3′-dimethoxy-4,4′-diisocyanate and toluene diisocyanate (TDI); as well as aliphatic diisocyanates such as isophorone diisocyanate (IPDI), 1,4-cyclohexyl diisocyanate (CHDI), decane-1,10-diisocyanate, and dicyclohexylmethane-4,4′-diisocyanate. The most preferred diisocyanate is 4,4′-methylenebis(phenyl isocyanate), i.e., MDI. When a higher molecular weight TPU polymer is desired, it can be achieved by using a small amount of a cross linking agent having a functionality greater than 2.0 to induce cross linking. The amount of cross linking agent used is preferably less than 0.2 weight percent of the TPU polymer, and more preferably less than 0.1 weight percent. A particularly desirable method to increase the molecular weight in the preferred TPU polymer is to replace less than 1 mole percent of the 1,4-butanediol chain extender with trimethylol propane (TMP).

Each of the types of TPU, such as the polyester, polyether or polycarbonate TPU has a particular advantage in certain applications. Polyether TPU is the preferred TPU for wire and cable jacketing applications because polyether TPU has better hydrolytic stability, lower Tg (improved flexibility at low temperatures), and improved microbial resistance than polyester TPU.

For wire and cable jacketing, the TPU composition should have a Shore A durometer of from 78 to 98, preferably from 85 to 95. Softer TPU compositions are more difficult to achieve V-0 rating on UL-94 test and are more difficult to achieve high LOI.

In addition to the TPU polymer, which is the first necessary ingredient of the TPU composition of this invention, the composition contains other necessary ingredients. The second necessary ingredient of the composition is at least one halogenated flame retardant compound. The halogenated flame retardant compound is selected from the group consisting of chlorinated compounds and brominated compounds. The level of halogenated flame retardant compounds used in the TPU composition of this invention is from about 10 to about 25, preferably 10 to 20 weight percent of the TPU composition. Preferred brominated flame retardant compounds include those selected from the group consisting of decabromo diphenyloxide (Saytex® 102E), benzene, 1,1′-(1,2-ethanediyl)bis[2,3,4,5,6-pentabromo-] (Saytex® 8010), and 1,2-bis(tetrabromophthalimido)ethane (Saytex® BT-93W), and mixtures thereof, all commercially available from Albemarle Corporation. Saytex® 8010 is also referred to as ethane-1,2-bis(pentabromophenyl) and has a formula of Br₁₀C₁₄H₄. The Saytex® 8010 brominated flame retardant is the most preferred brominated compound because it gives excellent flame retardant results and it is a non-diphenyl oxide compound and therefore is in compliance with the newer REACH European Regulations. Suitable brominated compounds will have a bromine content of from about 60 to about 85 weight percent bromine. Preferred chlorinated flame retardant compounds include a C₁₈H₁₂C₁₂ compound commercially available from Occidental Chemical Corporation under the name Dechlorane Plus®.

Other halogenated compounds may optionally be used in the TPU composition of this invention in addition to the halogenated flame retardants. Examples of other halogenated compounds include chlorinated polyethylene which, if used, is preferably used at a level of 5 to 25 weight percent of the total TPU composition. Also, fluoropolymer resin, such as Teflon® PTFE from DuPont, may be used to improve processing such as in preventing excessive die drool during extrusion. The PTFE resin is preferably used at low levels, such as from 0.05 to 1.0 weight percent of the total TPU composition.

The third necessary ingredient of the TPU composition is an antimony oxide compound selected from the group consisting of antimony trioxide and antimony pentaoxide. Antimony oxide is preferably present at a level of from 30 weight % to 70 weight % of the level of halogenated flame retardant and more preferably from 45 weight % to 55 weight percent. As an example, if the halogenated flame retardant was used at a 15.0 weight percent level, then the antimony oxide compound would be used at a level of 4.5 to 10.5 weight percent level of the TPU composition. The preferred antimony oxide compound is antimony trioxide and the preferred level used is from 5.0 to 8.0 weight percent of the TPU composition and more preferred a level of from 6.0 to 7.0 weight percent is used.

The fourth necessary ingredient of the TPU composition of this invention is talc. It was unexpected that a small level of talc would have such a dramatic effect on the LOI and UL-94 test results of the TPU composition. The level of talc used is from 1.0 to 20.0 weight percent of the TPU composition, preferably from 3.0 to 15.0 weight percent and more preferably from 5.0 to 10.0 weight percent.

Other conventional TPU additives may be used in the TPU composition of this invention. Conventional additives include antioxidants, UV stabilizers, metal release agents such as wax and calcium sterate, and colorants. The conventional additives are normally used at levels of from 0.5 to 5 weight percent, and preferably from 1.0 to 3.0 weight percent.

Although the flame retardant system of this invention will work on all TPU polymers, the flame retardant system for TPU of this invention is designed to work better on softer TPU, such as from 78-98 Shore A durometer, as opposed to harder TPUs. A typical application for these soft TPUs is wire and cable applications.

To demonstrate the effectiveness of the flame retardant system of this invention, an important property to test is the LOI. For many polymers, the limiting oxygen index (LOI) can be linearly related to char formation. That is, the higher the LOI, the better the char formation. The LOI is the minimum percentage of oxygen which allows a sample to sustain combustion under specified conditions in a candle-like fashion, and thus may be considered to measure the ease of extinction of a sample. The LOI test has been formalized as ASTM D2863. The LOI values of the TPU compositions of this invention are at least 30, preferably 31, 32, 33, 34 or 35 or greater and can be as high as 40 or more.

Another important test for flammability is the Underwriters Laboratories Vertical Burn Standard—UL94 (UL-94) test. The TPU compositions of this invention have a UL-94 rating of VO at a thickness of about 75 mils (1.90 mm). The UL-94 rating should always be reported with the thickness.

The desired TPU polymer utilized in the TPU composition is generally made from the above-noted intermediates (polyisocyanate, hydroxyl terminated intermediate, and chain extender glycol) in a so-called one-shot process or simultaneous co-reaction of polyester, polycarbonate or polyether intermediate; polyisocyanate; and extender to produce a high molecular weight linear TPU polymer.

In the one-shot polymerization process which generally occurs in situ, a simultaneous reaction occurs between three components, that is, the one or more intermediates, the one or more polyisocyanates, and the one or more chain extenders, with the reaction generally being initiated at temperatures of from about 100° C. to about 120° C. Inasmuch as the reaction is exothermic, the reaction temperature generally increases to about 220° C.-250° C. In one exemplary embodiment, the TPU polymer may be pelletized following the reaction. The flame retardant components may be incorporated with the TPU polymer pellets to form a flame retardant composition in a subsequent compounding process.

The TPU polymer and flame retardant components may be compounded together by any means known to those skilled in the art. If a pelletized TPU polymer is used, the polymer may be melted at a temperature of about 150° C. to 215° C., preferably from about 160-190° C., and more preferably from about 170-180° C. The particular temperature used will depend on the particular TPU polymer used, as is well understood by those skilled in the art. The TPU polymer and the flame retardant components are blended to form an intimate physical mixture. Blending can occur in any commonly used mixing device able to provide shear mixing, but a twin screw extruder having multiple heat zones with multiple feeding ports is preferably used for the blending and melting process (compounding).

The TPU polymer and flame retardant components may be pre-blended before adding to the compounding extruder or they may be added or metered into the compounding extruder in different streams and in different zones of the extruder.

In an alternate embodiment, the TPU polymer is not pelletized prior to the addition of the flame retardant components. Rather, the process for forming a flame retardant thermoplastic polyurethane composition is a continuous in situ process. The ingredients to form the thermoplastic polyurethane polymer are added to a reaction vessel, such as a twin screw extruder as set forth above. After formation of the thermoplastic polyurethane polymer, the flame retardant components may be added or metered into the extruder in different streams and/or in different zones of the extruder in order to form a thermoplastic polyurethane composition.

The resultant TPU composition may exit the extruder die in a molten state and be pelletized and stored for further use in making finished articles. The finished articles may comprise injection-molded parts, especially using TPU compositions based on polyester polyurethane. Other finished articles may comprise extruded profiles. The TPU composition may be utilized as a cable jacket especially using TPU compositions based on polyether polyurethane.

Thermoplastic polyurethanes are generally valued in end use applications because of their abrasion and wear resistance, low temperature flexibility, toughness and durability, ease of processing, and other attributes. When additives, such as flame retardants, are present in a TPU composition, there may be some reduction in the desired material properties. The flame retardant package should thus impart the desired flame retardancy without unduly sacrificing other material properties.

The disclosed TPU compositions, because of their flame retardant properties, abrasion resistance and good tensile strength, are particularly suited for use as jacketing for electrical conductors in wire and cable construction applications. The TPU compositions of this invention may also be used as jacketing in fiber optic cables, such as where a glass or plastic is used to conduct light. One or more insulated conductors, either metal electrical conductors or non-metal optical conductors, may be wrapped with insulating material such as a fiberglass or other non-flamable textile. The one or more conductors are then encased in a jacket material (i.e., the TPU composition) to protect the insulated electrical or optical conductors. It is necessary for this jacket material to be flame resistant in case a fire occurs.

The types of wire and cable constructions that are most suitable for using a jacket made from the TPU compositions are detailed in the UL-1581 standard. The UL-1581 standard contains specific details of the conductors, of the insulation, of the jackets and other coverings, and of the methods of sample preparation, of specimen selection and conditioning, and of measurement and calculation.

The fire performance of a wire and cable construction can be influenced by many factors, with the jacket being one factor. The flammability of the insulation material can also affect the fire performance of the wire and cable construction, as well as other inner components, such as paper wrappings, fillers, and the like.

Exemplary embodiments of wire and cable constructions are made by extruding the TPU composition onto a bundle of insulated conductors to form a jacket around the insulated conductors. The conductor is typically metal, such as copper, but can be non-metal such as glass or plastic in fiber-optic applications. Each conductor will be coated, normally by extrusion, with a thin layer of polymeric insulation which can be polyvinyl chloride, polyethylene, cross-linked polyethylene, fluorocarbon polymers, and the like. The jacket made from the TPU composition of this invention is extruded around the bundle of conductors. The thickness of the jacket depends on the requirements of the desired end use application. The thinnest jacket is typically about 30 mils (0.762 mm) and therefore, a V-0 rating by the UL-94 test is most desirable at that thickness.

The TPU compositions may be extruded into the jacket from previously made TPU composition. Usually, the TPU composition is in the form of pellets for easy feeding into the extruder. This method is the most common since the TPU composition is not normally made by the same party that makes the wire and cable construction. However, in accordance with an exemplary embodiment of the invention, the wire and cable jacket could be extruded directly from the compounding extruder without going through the separate step of pelletizing the flame retardant TPU composition.

Another property of the clean TPU which may be altered upon addition of flame retardant components is processability. Thus, it is advantageous to employ a flame retardant package that only minimally impairs processability, if at all. For purposes of this disclosure “processability” refers to two phases: the initial compounding (and pelletizing) of the TPU composition and secondary processing. In the initial compounding phase, the desired qualities relate to strand integrity, lack of die drool, uniformity in pelletizing, and the like. In secondary processing, additional qualities may be desired such as the ability to extrude a sheet, aesthetic appearance, lack of brittleness, smooth surface (not bumpy or gritty), and so on.

### EXAMPLES

The examples evaluated the flame retardant system in a polyether TPU. The ingredients of the TPU composition were mixed together (compounded) in a Warner Pfeider ZSK30 twin screw extruder having 4 heating zones, and operating at 100 RPM with a feed rate of 25 pounds per hour. The TPU polymer was in pellet form when it was fed to the extruder. The TPU composition containing the flame retardant additives exited the extruder through a die and was pelletized and stored for further testing.

The physical properties of the formulations in the Examples were tested using the following ASTM test methods:

| | |
|---|---|
| Shore A Hardness | ASTM D-2240 |
| Tensile Strength | ASTM D-412 |
| Ultimate Elongation | ASTM D-412 |
| Graves Tear Strength | ASTM D-624 (die c) |
| Trouser Tear Strength | ASTM D-470 |
| Taber Loss (1000 rev.) | ASTM D-3389 (H18, 1000 g) |
| Limiting Oxygen Index (LOI %) | ASTM D-2863 |
| Verticle Flame, UL-94 75 mils | ASTM D-3801 |
| Flexural Modulus | ASTM D-790 |

### Examples 1-4

Examples 1-4 are presented to show the effects of talc in a chlorinated flame retarded TPU formulation. The TPU used was an 85 Shore A durometer polyether TPU. Example 2 is a comparative example which does not contain talc.

The results show that the Example 2 (comparative) formulation with no talc has a V-2 rating on the UL-94 test. The Examples 1, 3 and 4 all show a V-0 rating. This was very surprising that 5.0 weight percent talc would raise UL-94 performance from V-2 to V-0. All formulations have LOI % results greater than 30.

The formulations and test results for Examples 1-4 are shown below in Tables I and II respectively.

TABLE I

Example Formulation

| | | | |
|---|---|---|---|
| | 2 | | |
| 1 | (Comparative) | 3 | 4 |

| | |
|---|---|
| Ingredient | Weight Percent |

| | | | | |
|---|---|---|---|---|
| TPU¹ | 57.95 | 62.75 | 57.75 | 52.75 |
| CPE² | 11.00 | 20.00 | 20.00 | 20.00 |
| Dechlorane Plus³ | 13.20 | 10.00 | 10.00 | 10.00 |
| Antimony Trioxide | 6.60 | 6.00 | 6.00 | 6.00 |
| Miston Vapor Talc | 10.00 | — | 5.00 | 10.00 |
| Wax | 0.70 | 0.70 | 0.70 | 0.70 |
| Calcium Stearate | 0.30 | 0.30 | 0.30 | 0.30 |
| Viton Z200⁴ | 0.05 | 0.05 | 0.05 | 0.05 |
| Antioxidant⁵ | 0.10 | 0.10 | 0.10 | 0.10 |
| UV Stabilizer⁶ | 0.10 | 0.10 | 0.10 | 0.10 |

¹TPU is an 85 Shore A polyether TPU made from 1000 Mₙ PTMEG, butane diol and MDI commercially available as Estane ® 58325 from Lubrizol Advanced Materials, Inc.
²CPE is chlorinated polyethylene available from Dow Chemical as Tyrin ® CM0132.
³Dechlorane Plus ® is a C₁₈H₁₂Cl₁₂ chlorinated flame retardant available from OxyChem ®.
⁴Viton Z200 is a fluoropolymer resin available from DuPont ® as Teflon ® PTFE 6C.
⁵Antioxidant is Stalite ® S available from Emerald Performance Chemicals.
⁶UV Stabilizer is Irganox ® 245 available from Ciba Geigy.

TABLE II

| | Formulation from Examples | | | |
|---|---|---|---|---|
| Physical Property | 1 | 2 | 3 | 4 |
| Flex Modulus Psi | 4340 | 2430 | 2730 | 4260 |
| (0.5 in/min) | | | | |

Trouser Tear

| | | | | |
|---|---|---|---|---|
| lb-Force | 8 | 6.9 | 8.8 | 5.9 |
| lb-Force/in | 103 | 99 | 117 | 91 |

Graves Tear

| | | | | |
|---|---|---|---|---|
| lb-Force | 26.5 | 23 | 34 | 21.2 |
| lb-Force/in | 395 | 368 | 401 | 336 |

Tensile Stress (Psi) @ % Elongation

| | | | | |
|---|---|---|---|---|
| 50 | 864 | 692 | 750 | 823 |
| 100 | 920 | 780 | 834 | 894 |
| 200 | 1010 | 896 | 938 | 983 |
| 300 | 1220 | 1150 | 1160 | 1170 |
| 400 | 1720 | 1740 | 1660 | 1610 |
| 500 | 2640 | 2870 | 2600 | 2410 |
| Stress (Psi) at Break | 3980 | 4650 | 3910 | 3570 |
| % Elongation at Break | 617 | 602 | 602 | 611 |

Aged Tensile 7 days @ 121° C.
Stress (Psi) at % Elongation

| | | | | |
|---|---|---|---|---|
| 50 | 772 | 561 | 633 | 746 |
| 100 | 919 | 699 | 765 | 882 |
| 200 | 1070 | 896 | 934 | 1020 |
| 300 | 1250 | 1110 | 1120 | 1180 |
| 400 | 1520 | 1420 | 1400 | 1420 |
| 500 | 1940 | 1880 | 1830 | 1800 |
| Stress (Psi) at Break | 3050 | 3700 | 3290 | 2990 |
| % Elongation at Break | 708 | 729 | 713 | 709 |
| LOI % | 35 | 33 | 34 | 32 |
| UL-94 @ 75 mils | V-0 | V-2 | V-0 | V-0 |

Shore A Hardness

| | | | | |
|---|---|---|---|---|
| Peak | 88.4 | 84.8 | 86.0 | 87.6 |
| 5 Seconds | 85.9 | 81.9 | 83.1 | 83.1 |
| Vicat B | 58.8 | 60.5 | 59.1 | 56.3 |

Taber Abrasion H-18
1000 Cycles 1000 Grams

| | | | | |
|---|---|---|---|---|
| Loss of Mass in Grams | 0.1839 | 0.1401 | 0.1956 | 0.705 |

### Examples 5-7

Examples 5-7 are presented to show flame retarded TPU formulations which contain chlorine based flame retardants together with antimony trioxide and talc. The TPU used in Examples 5-7 is an 85 Shore A durometer polyether TPU which has 0.15 weight percent of trimethyl propane to give slight crosslinking and to build weight average molecular weight.

The formulations all show V-0 ratings on the UL-94 test and have high LOI %.

The formulations and test results for Examples 5-7 are shown below in Tables III and IV respectively.

TABLE III

| | Example Formulation | | |
|---|---|---|---|
| | 5 | 6 | 7 |
| Ingredient | Weight Percent | | |
| TPU⁷ | 58.05 | 58.15 | 55.15 |
| CPE² | 11.00 | 16.80 | 16.80 |
| Dechlorane Plus³ | 13.20 | 12.60 | 12.60 |
| Antimony Trioxide | 6.60 | 6.30 | 6.30 |
| Mistron Vapor Talc | 10.00 | 5.00 | 8.00 |
| Wax | 0.45 | 0.45 | 0.45 |
| Calcium Stearate | 0.45 | 0.45 | 0.45 |
| Viton Z200⁴ | 0.05 | 0.05 | 0.05 |
| Antioxidant⁵ | 0.10 | 0.10 | 0.10 |
| UV Stabilizer⁶ | 0.10 | 0.10 | 0.10 |

⁷TPU is an 85 Shore A polyether TPU made from 1000 Mₙ PTMEG, butanediol and MDI with 0.15 weight percent trimethyl propane (TMP) and is commercially available as Estane ® 58315 from Lubrizol Advanced Materials, Inc.
²CPE is chlorinated polyethylene available from Dow Chemical as Tyrin ® CM0132.
³Dechlorane Plus ® is a C₁₈H₁₂Cl₁₂ chlorinated flame retardant available from OxyChem ®.
⁴Viton Z200 is a fluoropolymer resin available from DuPont ® as Teflon ® PTFE 6C.
⁵Antioxidant is Stalite ® S available from Emerald Performance Chemicals.
⁶UV Stabilizer is Irganox ® 245 available from Ciba Geigy.

TABLE IV

| | Formulation From Examples | | |
|---|---|---|---|
| Physical Property | 5 | 6 | 7 |
| Flex Modulus Psi (0.5 in/min) | 4990 | 3400 | 3930 |

Trouser Tear

| | | | |
|---|---|---|---|
| lb-Force | 8.5 | 7.2 | 7 |
| lb-Force/in | 112 | 105 | 96 |

Graves Tear - 75 mil

| | | | |
|---|---|---|---|
| lb-Force | 26.2 | 33.7 | 26.5 |
| lb-Force/in | 426 | 406 | 384 |

Tensile Stress (Psi) @ Elongation

| | | | |
|---|---|---|---|
| 50 | 958 | 805 | 814 |
| 100 | 1030 | 892 | 871 |
| 200 | 1220 | 1010 | 972 |
| 300 | 1600 | 1220 | 1180 |
| 400 | 2260 | 1650 | 1610 |
| 500 | 3350 | 2340 | 2430 |
| Stress (Psi) at Break | 3910 | 3570 | 3570 |
| % Elongation at Break | 540 | 615 | 613 |

Aged Tensile 7 days @ 121° C.
Stress (Psi) at % Elongation

| | | | |
|---|---|---|---|
| 50 | 915 | 695 | 745 |
| 100 | 1080 | 882 | 898 |
| 200 | 1300 | 1140 | 1070 |
| 300 | 1570 | 1370 | 1250 |
| 400 | 1920 | 1660 | 1490 |
| 500 | 2380 | 2080 | 1870 |
| Stress (Psi) at Break | 2970 | 2760 | 2660 |
| % Elongation at Break | 611 | 634 | 664 |
| LOI % | 35 | 35 | 34 |
| UL-94 @ 75 mils | V-0 | V-0 | V-0 |

Shore A Hardness

| | | | |
|---|---|---|---|
| Peak | 90.2 | 88.9 | 88.4 |
| 5-Seconds | 88.2 | 86.1 | 85.9 |

Taber Abrasion H-18
1000 Cycles 1000 Grams

| | | | |
|---|---|---|---|
| Loss of Mass in Grams | 0.1709 | 0.1715 | 0.1899 |

### Examples 8-9

Examples 8 and 9 are presented to show two levels of talc (10 wt. % and 5 wt. %) with a chlorinated flame retardant and mixed into a 95 Shore A polyether TPU. Both of the formulations show a UL-94 at 75 mils with a V-0 rating. The formulation with 10 wt. % talc (Example 8) has a LOI % of 33 while the formulation with 5 wt. % talc has a LOI % of 32. These Examples show that even a small amount of talc is sufficient to achieve a LOI % of at least 30.

The formulations and test results for Examples 8-9 are shown below in Tables V and VI respectively.

TABLE V

Example
Formulation

| | |
|---|---|
| 8 | 9 |

| | |
|---|---|
| Ingredient | Weight Percent |

| | | |
|---|---|---|
| TPU⁸ | 58.05 | 58.15 |
| CPE² | 11.00 | 11.00 |
| Dechlorane Plus³ | 13.20 | 13.20 |
| Antimony Trioxide | 6.60 | 6.60 |
| Mistron Vapor Talc | 10.00 | 5.00 |
| Wax | 0.45 | 0.45 |
| Calcium Stearate | 0.45 | 0.45 |
| Viton Z200⁴ | 0.05 | 0.05 |
| Antioxidant⁵ | 0.10 | 0.10 |
| UV Stabilizer⁶ | 0.10 | 0.10 |

⁸TPU is a 95 Shore A polyether TPU commercially available as Estane ® 58212 from Lubrizol Advanced Materials, Inc.
²CPE is chlorinated polyethylene available from Dow Chemical as Tyrin ® CM0132.
³Dechlorane Plus ® is a C₁₈H₁₂Cl₁₂ chlorinated flame retardant available from OxyChem ®.
⁴Viton Z200 is a fluoropolymer resin available from DuPont ® as Teflon ® PTFE 6C.
⁵Antioxidant is Stalite ® S available from Emerald Performance Chemicals.
⁶UV Stabilizer is Irganox ® 245 available from Ciba Geigy.

TABLE VI

Formulation
from Examples

| Physical Property | 8 | 9 |
|---|---|---|
| Flex Modulus Psi (0.5 in/min) | 11600 | 7820 |

Trouser Tear

| | | |
|---|---|---|
| lb-Force | 8 | 9.8 |
| lb-Force/in | 115 | 110 |

Graves Tear - 75 mil

| | | |
|---|---|---|
| lb-Force | 36.1 | 31.8 |
| lb-Force/in | 493 | 384 |

Tensile Stress (Psi) @ % Elongation

| | | |
|---|---|---|
| 50 | 1330 | 1110 |
| 100 | 1430 | 1220 |
| 200 | 1750 | 1510 |
| 300 | 2370 | 2120 |
| 400 | — | 3070 |
| 500 | — | — |
| Stress Psi at Break | 3520 | 3420 |
| % Elongation at Break | 410 | 432 |

Aged Tensile 7 days at 121° C.
Stress (Psi) at % Elongation

| | | |
|---|---|---|
| 50 | 1410 | 1130 |
| 100 | 1530 | 1260 |
| 200 | 1760 | 1500 |
| 300 | 2130 | 1830 |
| 400 | 2710 | 2360 |
| 500 | — | 2360 |
| Stress (Psi) at Break | 2870 | 3000 |
| % Elongation at Break | 425 | 509 |
| LOI % | 33 | 32 |
| UL-94 at 75 mils | V-0 | V-0 |

Shore A Hardness

| | | |
|---|---|---|
| Peak | 94.5 | 92.7 |
| 5 Seconds | 93.3 | 90.8 |

Taber Abrasion H-18
1000 Cycles 1000 Grams

| | | |
|---|---|---|
| Loss of Mass in Grams | 0.2428 | 0.2574 |

### Examples 10-15

Examples 10-15 are presented to show a bromonated flame retardant system which also contains antimony trioxide. Talc was not used in Examples 10-15. Examples 10-12 uses 3 different bromonated flame retardants added to an 85 Shore A durometer TPU. Examples 13-15 uses a 95 Shore A durometer TPU with the same 3 bromonated flame retardants. All formulations (10-15) show a V-0 rating on UL-94 test (30 mil sample) and a LOI % of at least 30.

While the chlorinated flame retardants in other Examples shown in this specification require the presence of talc to achieve a LOI % of at least 30, the bromonated flame retardants unexpectedly do not require talc to achieve this level of LOI and a UL-94 V-0 rating testing on a 30 mil sample. Particular attention is directed to Example 13, where a pentabromo flame retardant was used with a 95 Shore A TPU and achieved a LOI % of 37. Although the level of bromine in the pentabromo flame retardant (82.3%) was slightly less than the decabromo compound (83.3%) used in Example 15, the LOI % of Example 13 was much higher than Example 15 (37 vs. 30). This was very unexpected. A LOI % increase of 7 is very significant.

The formulations and test results for Examples 10-15 are shown below in Tables VII and VIII respectively.

TABLE VII

| | Example Formulation - wt. % | | | | | |
|---|---|---|---|---|---|---|
| Ingredient | 10 | 11 | 12 | 13 | 14 | 15 |
| TPU⁷ | 74.00 | 70.00 | 74.00 | — | — | — |
| TPU⁸ | | | | 74.00 | 70.00 | 74.00 |
| Bromonated F.R.⁹ | — | — | 18.50 | — | | 18.50 |
| Bromonated F.R.¹⁰ | 18.50 | — | — | 18.50 | | — |
| Bromonated F.R.¹¹ | — | 21.50 | — | — | 21.50 | — |
| Antimony Trioxide | 6.00 | 7.00 | 6.00 | 6.00 | 7.00 | 6.00 |
| Wax | 0.50 | 0.50 | 0.50 | 0.50 | 0.50 | 0.50 |
| Calcium Stearate | 0.50 | 0.50 | 0.50 | 0.50 | 0.50 | 0.50 |
| Viton Z200⁴ | 0.50 | 0.50 | 0.50 | 0.50 | 0.50 | 0.50 |

⁹is decabromo diphenyloxide available as Saytex ® 102E from Albemarle Corp. and contains 83.3% by weight Bromine.
¹⁰is Benzene, 1,1′-(1,2-ethanediyl)bis[2,3,4,5,6-pentabromo-] available as Saytex ® 8010 from Albemarle Corp. and contains 82.3% by weight Bromine.
¹¹is 1,2-bis(tetrabromophthalimido)ethane available as Saytex ® BT-93W from Albemarle Corp. and contains 67.2% by weight Bromine.
⁷TPU is an 85 Shore A polyether TPU made from 1000 Mₙ PTMEG, butanediol and MDI with 0.15 weight percent trimethyl propane (TMP) and is commercially available as Estane ® 58315 from Lubrizol Advanced Materials, Inc.
⁸TPU is a 95 Shore A polyether TPU commercially available as Estane ® 58212 from Lubrizol Advanced Materials, Inc.
⁴Viton Z200 is a fluoropolymer resin available from DuPont ® as Teflon ® PTFE 6C.

TABLE VIII

| | Formulation From Examples | | | | | |
|---|---|---|---|---|---|---|
| Physical Property | 10 | 11 | 12 | 13 | 14 | 15 |
| Flex Modulus Psi (0.5 in/min) | 4790 | 5580 | 4320 | 10900 | 16700 | 10200 |

Trouser Tear

| | | | | | | |
|---|---|---|---|---|---|---|
| lb-Force | 3.9 | 4.0 | 4.5 | 4.0 | 4.1 | 5.2 |
| lb-Force/in | 132 | 138 | 146 | 146 | 143 | 160 |

Graves Tear

| | | | | | | |
|---|---|---|---|---|---|---|
| lb-Force | 34.2 | 35.3 | 36.3 | 38.7 | 45.1 | 65.3 |
| lb-Force/in | 471 | 452 | 479 | 558 | 595 | 562 |

Tensile Stress (Psi) at % Elongation

| | | | | | | |
|---|---|---|---|---|---|---|
| 50 | 831 | 898 | 846 | 1350 | 1460 | 1590 |
| 100 | 911 | 966 | 964 | 1540 | 1590 | 1800 |
| 200 | 1090 | 1130 | 1110 | 2070 | 1980 | 2180 |
| 300 | 1400 | 1400 | 1340 | 3090 | 2720 | 2930 |
| 400 | 1970 | 1850 | 1800 | 4370 | 4080 | 4000 |
| 500 | 3020 | 2630 | 2740 | — | — | — |
| Stress (Psi) at Break | 4870 | 4030 | 5040 | 5270 | 4390 | 4600 |
| % Elongation at Break | 603 | 609 | 641 | 429 | 420 | 418 |

UL-94 20 mm Flame

| | | | | | | |
|---|---|---|---|---|---|---|
| 30 mil Sample | V-0 | V-0 | V-0 | V-0 | V-0 | V-0 |
| LOI % | 32 | 32 | 30 | 37 | 30 | 30 |

Shore A Hardness

| | | | | | | |
|---|---|---|---|---|---|---|
| Peak | 91.2 | 91.9 | 91.1 | 96.1 | 97.3 | 96.3 |
| 5-Seconds | 89.1 | 90.2 | 89.1 | 95.0 | 96.5 | 95.4 |

### Example 16

Example 16 is presented to show a TPU formulation having a hardness of Shore A 98 which has an exceptionally high LOI % of 40 and a UL-94 V-0 rating. This exceptionally high LOI is achieved by using a brominated flame retardant (82.3% by weight bromine) together with antimony trioxide and 10 weight percent talc. An LOI of 40 for a TPU compound is very unusual and it was very unexpected that such a high LOI % could be achieved. Another surprising property of this Example 16 is the low average heat of combustion of 10.9 MJ/Kg. A similar TPU without the flame retardant package has an average heat of combustion of about 26.5 MJ/Kg.

The formulation and test results for Example 16 are shown below in Tables IX and X respectively.

TABLE IX

| | Example Formulation |
|---|---|
| Ingredient | 16 - wt. % |
| TPU⁸ | 62.00 |
| Bromonated F.R.¹⁰ | 18.70 |
| Antimony Trioxide | 6.60 |
| Mistron Vapor Talc | 10.00 |
| Wax | 0.85 |
| Calcium Stearate | 0.50 |
| Viton Z200¹¹ | 0.05 |
| Antioxidant¹² | 0.50 |
| UV Stabilizer¹³ | 0.50 |
| UV Stabilizer¹⁴ | 0.30 |

⁸TPU is a 95 Shore A polyether TPU commercially available as Estane ® 58212 from Lubrizol Advanced Materials, Inc.
¹⁰is Benzene, 1,1′-(1,2-ethanediyl)bis[2,3,4,5,6-pentabromo-] available as Saytex ® 8010 from Albemarle Corp. and contains 82.3% by weight Bromine.
⁴Viton Z200 is a fluoropolymer resin available from DuPont ® as Teflon ® PTFE 6C.
¹²is Irganox ® 1010 available from Ciba Geigy.
¹³is Tinuvin ® 328 available from Ciba Geigy.
¹⁴is Tinuvin ® 770 available from Ciba Geigy.

TABLE X

| | Formulation from |
|---|---|
| Physical Property | Example 16 |
| Flex Modulus Psi (0.5 in/min) | 30,300 |
| Trouser Tear (lb-Force/in) | 117 |
| Graves Tear (lb-Force/in) | 477 |

Tensile Stress (Psi) @ % Elongation

| | |
|---|---|
| 100 | 1500 |
| 300 | 2340 |
| Stress (Psi) at Break | 3620 |
| % Elongation at Break | 417 |
| LOI % | 40 |
| UL-94 at 75 mils | V-0 |
| Shore A Hardness (Peak) | 98 |
| Taber Abrasion H-18 | |
| 1000 Cycles 1000 Grams | |
| Loss of Mass in Grams | 0.268 |
| Average Heat of Combustion (MJ/Kg) | 10.9 |
| By Cone Calorimetry Operating on Oxygen | |
| Depletion Principle Conducted at a Heat Flux | |
| of 50 KW/m² | |

### Examples 17 and 18

Examples 17 and 18 are presented to show the effect of talc in a TPU flame retardant system for a soft TPU of about 80 Shore A hardness. The formulation of Example 17 is a comparative example which shows a lower LOI than Example 18. Also, the formulation of Example 17 has a UL-94 rating of V-2, whereas the formulation of Example 18 has a V-0 rating. The formulation in Example 17 was also evaluated (data not shown in Tables) using much higher levels of flame retardants (Dechlorane Plus® Antimony Trioxide and CPE) but V-0 could not be achieved. It was only when 10.0 weight percent of talc was added that V-0 was achieved. Soft TPU formulations as in Examples 17 and 18 are more difficult to achieve a UL-94 rating of V-0 and are also more difficult to achieve a LOI % greater than 30.

The formulations and test results of Examples 17 and 18 are shown below in Tables XI and XII respectively.

TABLE XI

Example Formulation
Formulation From
Examples - Wt. %

| Ingredient | 17 (Comparative) | 18 |
|---|---|---|
| TPU¹⁵ | 75.79 | 57.00 |
| CPE² | 11.37 | 11.00 |
| Dechlorane Plus³ | 7.58 | 13.20 |
| Antimony Trioxide | 3.79 | 6.60 |
| Mistron Vapor Talc | — | 10.00 |
| Wax | 1.14 | 0.70 |
| Calcium Stearate | 0.34 | 0.30 |
| Antioxidant¹² | — | 0.15 |
| UV Stabilizer¹³ | — | 0.40 |
| UV Stabilizer¹⁴ | — | 0.40 |
| UV Stabilizer¹⁶ | — | 0.10 |
| Antioxidant⁵ | — | 0.10 |
| Viton Z200⁴ | — | 0.05 |

¹⁵TPU is an 80 Shore A polyether TPU made from PTMEG, butane diol and MDI commercially available as Estane ® 58370 from Lubrizol Advanced Materials, Inc.
¹⁶is Irganox ® 245 available from Ciba Geigy.
²CPE is chlorinated polyethylene available from Dow Chemical as Tyrin ® CM0132.
³Dechlorane Plus ® is a C₁₈H₁₂Cl₁₂ chlorinated flame retardant available from OxyChem ®.
⁴Viton Z200 is a fluoropolymer resin available from DuPont ® as Teflon ® PTFE 6C.
⁵Antioxidant is Stalite ® S available from Emerald Performance Chemicals.
¹²is Irganox ® 1010 available from Ciba Geigy.
¹³is Tinuvin ® 328 available from Ciba Geigy.
¹⁴is Tinuvin ® 770 available from Ciba Geigy.

TABLE XII

Formulation From
Examples

| Physical Property | 17 | 18 |
|---|---|---|
| Flex Modulus-Psi (0.5 in/min) | 2570 | 3500 |
| Trouser Tear (lb-Force/in) | 100 | 90 |
| Graves Tear (lb-Force/in) | 415 | 285 |

Tensile Stress (Psi) at % Elongation

| | | |
|---|---|---|
| 100 | 697 | 660 |
| 300 | 1040 | 815 |
| Stress (Psi) at Break | 5900 | 2400 |
| % Elongation at Break | 620 | 720 |
| LOI % | 25 | 32 |
| UL-94 at 75 mils | V-2 | V-0 |
| Shore A Hardness (Peak) | 82 | 81 |
| Taber Abrasion H-18 | | |
| 1000 Cycles 1000 Grams | | |
| Loss of Mass in Grams | 0.060 | 0.350 |

While certain representative embodiments and details have been shown for the purpose of illustrating the subject invention, it will be apparent to those skilled in this art that various changes and modifications can be made therein without departing from the scope of the subject invention.

What is claimed is:

1. A flame retardant thermoplastic polyurethane composition comprising:
(a) at least one thermoplastic polyurethane polymer;
(b) at least one halogenated flame retardant selected from the group consisting of chlorine compounds and bromine compounds;
(c) at least one antimony oxide compound selected from the group consisting of antimony trioxide and antimony pentaoxide;
(d) talc, wherein said thermoplastic polyurethane composition has a LOI % of at least 30 as determined according to ASTM D-2863 and a V-0 rating on UL-94 test according to ASTM D-3801 as measured on a sample having a thickness of 75 mils (1.90 mm).

2. The thermoplastic polyurethane composition of claim 1, wherein said thermoplastic polyurethane polymer is a polyether polyurethane polymer.

3. The thermoplastic polyurethane composition of claim 1, wherein said halogenated flame retardant is present at a level of from 10 to 25 weight percent of said composition.

4. The thermoplastic polyurethane composition of claim 3, wherein said antimony oxide compound is present at a level of from 3.0 to 17.5 weight percent of said composition.

5. The thermoplastic polyurethane composition of claim 4, wherein said antimony oxide compound is present at a level of from 5.0 to 8.0 weight percent of said composition.

6. The thermoplastic polyurethane composition of claim 1, wherein said talc is present at a level of from 1.0 to 20.0 weight percent of said composition.

7. The thermoplastic polyurethane composition of claim 1, wherein said composition has a LOI % of at least 35 as determined according to ASTM D-2863.

8. The thermoplastic polyurethane composition of claim 1, wherein said thermoplastic polyurethane polymer has a Shore A hardness of from 78 to 98, as determined according to ASTM D-2240.

9. The thermoplastic polyurethane composition of claim 3, wherein said halogenated flame retardant is selected from the group consisting of a chlorine compound having the formula C₁₈H₁₂CL₁₂, decabromo diphenyloxide, benzene 1,1′-(1,2-ethanediyl)bis[2,3,4,5,6-pentabromo-], and 1,2-bis(tetrabromophthalimido)ethane.

10. The thermoplastic polyurethane composition of claim 6, wherein said talc is present at a level of from 3.0 to 15.0 weight percent of said composition.

11. The thermoplastic polyurethane composition of claim 10, wherein said talc is present at a level of from 5.0 to 10.0 weight percent of said composition.

12. The flame retardant thermoplastic polyurethane composition of claim 1, wherein said halogenated flame retardant is benzene 1,1′-(1,2-ethanediyl)bis[2,3,4,5,6-pentabromo-], and; wherein said antimony oxide is antimony trioxide and said antimony oxide is present at a level of from 5.0 to 8.0 weight percent of said composition; and wherein said talc is present at a level of from 5.0 to 10.0 weight percent of said composition; and wherein said thermoplastic polyurethane polymer is a polyether polyurethane and has a Shore A hardness of from about 85 to about 95 as determined according to ASTM D-2240; and wherein said composition has a LOI % of at least 40 as determined according to ASTM D-2863.

13. A flame retardant thermoplastic polyurethane composition comprising:
(a) at least one thermoplastic polyurethane polymer;
(b) at least one bromine containing flame retardant having from 60.0 to 85.0 weight percent bromine;
(c) at least one antimony oxide compound selected from the group consisting of antimony trioxide and antimony pentaoxide; and
wherein said thermoplastic polyurethane composition has a LOI % of at least 30 as determined according to ASTM D-2863 and a V-0 rating on UL-94 test according to ASTM D-3801 as measured on a sample having a thickness of 30 mils (0.763 μmm).

14. The flame retardant thermoplastic polyurethane composition of claim 13, wherein said thermoplastic polyurethane polymer is a polyether thermoplastic polyurethane having a Shore A hardness of from 78 to 98; and wherein said antimony oxide compound is antimony trioxide and is present at a level of from 5.0 to 8.0 weight percent of said composition.

15. The flame retardant thermoplastic polyurethane composition of claim 14, wherein said bromine containing flame retardant is benzene, 1,1′-(1,2-ethanediyl)bis[2,3,4,5,6-pentabromo-] and said bromine containing flame retardant is present at a level of from 10.0 to 20.0 weight percent of said composition.

16. A wire and cable or fiber optic cable construction comprising:
(a) at least one conductor selected from the group consisting of metal and non-metal, wherein said conductor is insulated with a non-conducting polymeric material; and
(b) a flame retardant jacket covering said insulated conductor; wherein said jacket is a thermoplastic polyurethane composition comprising:
(i) at least one thermoplastic polyurethane polymer;
(ii) at least one halogenated flame retardant selected from the group consisting of chlorine compounds and bromine compounds;
(iii) at least one antimony oxide compound selected from the group consisting of antimony trioxide and antimony pentaoxide; and
(iv) talc.

17. The wire and cable or fiber optic cable construction of claim 16, wherein said jacket is a polyether thermoplastic polyurethane composition; and wherein said thermoplastic polyurethane polymer has a Shore A hardness of from 78 to 98, as determined according to ASTM D-2440; and wherein said halogenated flame retardant is present at a level of from 10 to 25 weight percent of said composition; and wherein said antimony oxide compound is present at a level of from 3.0 to 17.5 weight percent of said composition; and wherein said talc is present at a level 3.0 to 15.0 weight percent of said composition.

18. A wire and cable or fiber optic cable construction comprising:
(a) at least one conductor selected from the group consisting of metal and non-metal, wherein said conductor is insulated with a non-conducting polymeric material; and
(b) a flame retarded jacket covering said insulated conductor; wherein said jacket is a thermoplastic polyurethane composition comprising:
(i) at least one polyether thermoplastic polyurethane polymer;
(ii) at least one brominated flame retardant having from 60.0 to 85.0 weight percent bromine;
(iii) at least one antimony oxide compound selected from antimony trioxide and antimony pentaoxide.

19. The wire and cable or fiber optic cable construction of claim 18, wherein said polyether thermoplastic polyurethane polymer has a Shore A hardness of from 78 to 98, as determined according to ASTM D-2240; and wherein said brominated flame retardant is present at a level of from 10.0 to 20.0 weight percent of said thermoplastic polyurethane composition.

20. The wire and cable or fiber optic cable construction of claim 19, wherein said brominated flame retardant is benzene, 1,1′-(1,2-ethanediyl)bis[2,3,4,5,6-pentabromo-].
